(19) United States
(12) Patent Application Publication
(10) Pub. No.: US 2017/0137725 A1
(43) Pub. Date: May 18, 2017

(54) MESOPOROUS AND MACROPOROUS CATALYST WITH A CO-MIXED ACTIVE PHASE, THE PREPARATION PROCESS THEREOF AND THE USE THEREOF IN HYDROTREATING OF RESIDUES

(71) Applicant: IFP Energies nouvelles, Rueil-Malmaison Cedex (FR)

(72) Inventors: Malika BOUALLEG, Villeurbanne (FR); Bertrand GUICHARD, Izeaux (FR)

(73) Assignee: IFP ENERGIES NOUVELLES, Rueil-Malmaison Cedex (FR)

(21) Appl. No.: 15/318,617

(22) PCT Filed: Jun. 9, 2015
(86) PCT No.: PCT/EP2015/062823

§ 371 Date: Dec. 13, 2016

(30) Foreign Application Priority Data
Jun. 13, 2014 (FR) 1455413

(51) Int. Cl. C10G 45/08; B01J 27/19; B01J 35/10; B01J 37/03; C01F 7/34; B01J 37/00; B01J 37/02; B01J 37/04; C01F 7/44; B01J 21/04; B01J 37/08

(52) U.S. Cl. CPC C10G 45/08; B01J 21/04; B01J 27/19; B01J 35/1019; B01J 35/1042; B01J 35/1061; B01J 35/1066; B01J 37/036; B01J 37/08; B01J 37/009; B01J 37/0236; B01J 37/04; C01F 7/441; C01F 7/34; C10G 2300/202

(57) ABSTRACT

Mesoporous and macroporous hydroconversion catalyst:
a predominantly calcined alumina oxide matrix;
a hydrogenating-dehydrogenating active phase with at least one VIB metal, optionally at least one VIII metal, optionally phosphorus,
   said active phase being at least partly co-mixed in said predominantly calcined alumina oxide matrix.

Preparation process for a residue hydroconversion/hydrotreating catalyst by co-mixing of the active phase with a particular alumina.

Use of the catalyst in hydrotreating processes, in particular hydrotreating of heavy feedstocks.

### TECHNOLOGICAL FIELD OF THE INVENTION

The invention relates to hydrotreating catalysts, in particular for the hydrotreating of residues, and relates to the preparation of co-mixed active phase hydrotreating catalysts having a texture and a formulation that are favourable to the hydrotreating of residues, in particular for hydrodemetallization. The preparation process according to the invention also makes it possible to avoid the impregnation step that is usually carried out on a previously formed support.

The invention consists of using catalysts with an active phase co-mixed in an aluminium oxide matrix comprising at least one group VIB element, optionally at least one group VIII element, as well as optionally the element phosphorus. Introduction of this type of active phase before the forming step by co-mixing with a particular alumina, itself derived from the calcination of a specific gel, makes it possible, unexpectedly, in hydrotreating processes, in particular of residues, in a fixed bed, but also in an ebullating bed process, to improve significantly the activity of the catalyst in hydrodesulphurization, but also in hydrodemetallization, relative to the co-mixed catalysts on boehmite, while significantly reducing the cost of manufacture thereof, relative to the impregnated catalysts of the prior art.

### PRIOR ART

It is known to a person skilled in the art that catalytic hydrotreating makes it possible, by bringing a hydrocarbon feedstock into contact with a catalyst whose properties, in terms of metals of the active phase and of porosity, are well adjusted beforehand, to reduce its content of asphaltenes, metals, sulphur and other impurities considerably, while improving the ratio of hydrogen to carbon (H/C) and while transforming it more or less partially to lighter cuts.

The fixed-bed processes for hydrotreating residues (commonly called “Resid Desulphurization” unit or RDS) lead to high refining performance: typically they make it possible to produce a cut with a boiling point greater than 370° C. containing less than 0.5% by weight of sulphur and less than 20 ppm of metals from feedstocks containing up to 5% by weight of sulphur and up to 250 ppm of metals (Ni+V). The different effluents thus obtained may serve as a base for producing heavy fuel oils of good quality and/or of pretreated feedstocks for other units such as catalytic cracking (“Fluid Catalytic Cracking”). On the other hand, the hydroconversion of the residue to cuts lighter than atmospheric residue (in particular gas oil and gasoline) is generally low, typically of the order of 10 to 20% by weight. In such a process, the feedstock, mixed with hydrogen beforehand, circulates through several fixed-bed reactors arranged in series and filled with catalysts. The total pressure is typically between 100 and 200 bar (10 and 20 MPa) and the temperatures are between 340 and 420° C. The effluents withdrawn from the last reactor are sent to a fractionating section.

Conventionally, the fixed-bed hydrotreating process consists of at least two steps (or sections). The first step called hydrodemetallization (HDM) mainly aims to remove most of the metals from the feedstock using one or more hydrodemetallization catalysts. This step mainly combines the operations of removal of vanadium and nickel and to a lesser extent of iron.

The second step or section, called hydrodesulphurization (HDS), consists of passing the product from the first step over one or more hydrodesulphurization catalysts that are more active in terms of hydrodesulphurization and hydrogenation of the feedstock, but are less tolerant of metals.

When the content of metals in the feedstock is too high (greater than 250 ppm) and/or when greater conversion (transformation of the heavy fraction 540° C.+(or 370° C.+) to a lighter fraction 540° C.- (or 370° C.-)) is sought, ebullating-bed hydrotreating processes are preferred. In this type of process (cf. M. S. Rana et al., Fuel 86 (2007), p 1216), the purification performance is lower than in the RDS processes, but hydroconversion of the residue fraction is high (of the order of 45 to 85% by volume). The high temperatures employed, comprised between 415 and 440° C., contribute to this high hydroconversion. The reactions of thermal cracking are in fact promoted, as the catalyst does not generally have a specific hydroconversion function. Moreover, the effluents formed by this type of conversion may present problems of stability (formation of sediments).

For the hydrotreating of residues, it is therefore essential to develop stable, high-performance multipurpose catalysts.

For ebullating-bed processes, patent application WO 2010/002699 in particular teaches that it is advantageous to use a catalyst the support of which has a median pore diameter comprised between 10 and 14 nm with a narrow distribution. It is stated there that less than 5% of the pore volume must be developed in the pores larger than 21 nm and, similarly, less than 10% of the volume must be observed in the small pores, smaller than 9 nm. U.S. Pat. No. 5,968,348 confirms that it is preferable to use a support whose mesoporosity remains close to 11 to 13 nm, with optionally the presence of macropores and a high BET surface area, here at least 175 m²/g.

For fixed-bed processes, patent U.S. Pat. No. 6,780,817 teaches that it is necessary to use a catalyst support that has at least 0.32 ml/g of macropore volume for stable fixed-bed operation. Moreover, such a catalyst has a median diameter, in the mesopores, from 8 to 13 nm and a high specific surface area of at least 180 m²/g.

Patent U.S. Pat. No. 6,919,294 also describes the use of so-called bimodal supports, i.e. mesoporous and macroporous, using large macropore volumes, but with a mesopore volume limited to 0.4 ml/g at most.

Patents U.S. Pat. No. 4,976,848 and U.S. Pat. No. 5,089,463 describe a catalyst for hydrodemetallization and hydrodesulphurization of heavy feedstocks comprising a hydrogenating active phase based on metals of groups VI and VIII and a refractory oxide inorganic support, the catalyst having precisely between 5 and 11% of its pore volume in the form of macropores and having mesopores of median diameter greater than 16.5 nm.

Patent U.S. Pat. No. 7,169,294 describes a catalyst for the hydroconversion of heavy feedstocks, comprising between 7 and 20% of group VI metal and between 0.5 and 6% by weight of group VIII metal, on an alumina support. The catalyst has a specific surface area comprised between 100 and 180 m²/g, a total pore volume greater than or equal to 0.55 ml/g, at least 50% of the total pore volume consists of pores larger than 20 nm, at least 5% of the total pore volume consists of pores larger than 100 nm, at least 85% of the total pore volume consisting of pores with a size comprised between 10 and 120 nm, less than 2% of the total pore volume being contained in the pores with a diameter greater than 400 nm, and less than 1% of the total pore volume being contained in the pores with a diameter greater than 1000 nm.

Numerous developments relate in particular to optimization of the pore distribution of the catalyst or of mixtures of catalysts by optimizing the catalyst support.

Thus, patent U.S. Pat. No. 6,589,908 describes for example a preparation process for an alumina that is characterized by the absence of macropores, less than 5% of the total pore volume consisting of pores with a diameter greater than 35 nm, a high pore volume greater than 0.8 ml/g, and a bimodal distribution of mesopores in which the two modes are 1 to 20 nm apart and the primary pore mode is greater than the median pore diameter. For this purpose, the manner of preparation described employs two steps of precipitation of alumina precursors under well-controlled conditions of temperature, pH and flow rates. The first step operates at a temperature comprised between 25 and 60° C., and pH comprised between 3 and 10. The suspension is then heated to a temperature comprised between 50 and 90° C. Reagents are added to the suspension again, and it is then washed, dried, formed and calcined in order to form a catalyst support. Said support is then impregnated with a solution of active phase in order to obtain a hydrotreating catalyst; a catalyst for hydrotreating residues on a mesoporous monomodal support with median pore diameter of about 20 nm is described.

Patent U.S. Pat. No. 7,790,652 describes hydroconversion catalysts which can be obtained by coprecipitation of an alumina gel, and then introduction of the metals on the support obtained by any method known to a person skilled in the art, in particular by impregnation. The catalyst obtained has a mesoporous monomodal distribution with a mesopore median diameter comprised between 11 and 12.6 nm and a pore distribution width of less than 3.3 nm.

Alternative approaches to the conventional introduction of metals on alumina supports have also been developed, such as incorporation of catalyst fines in the support. Thus, patent application WO2012/021386 describes hydrotreating catalysts comprising a support of the refractory porous oxide type formed from alumina powder and 5 to 45% by weight of catalyst fines. The support comprising the fines is then dried and calcined. The support obtained has a specific surface area comprised between 50 m²/g and 450 m²/g, an average pore diameter comprised between 50 and 200 Å (5 to 20 nm), and a total pore volume exceeding 0.55 cm³/g. The support thus comprises incorporated metal owing to the metals contained in the catalyst fines. The resultant support can be treated using a chelating agent. The pore volume may be partially filled by means of a polar additive, and may then be impregnated with a metallic impregnation solution.

Judging from the prior art, it seems very difficult to obtain, by simple means, a catalyst having both a bimodal porosity, with a high mesopore volume coupled to a consistent macropore volume, a very large median diameter of the mesopores, and a hydrogenating-dehydrogenating active phase. Moreover, the increase in porosity is often at the expense of the specific surface area, and mechanical strength.

Surprisingly, the applicant discovered that a catalyst prepared from an alumina resulting from the calcination of a specific alumina gel having a low dispersibility, by co-mixing a hydrogenating-dehydrogenating active phase with the calcined alumina, had a porous structure that is particularly interesting for hydrotreating heavy feedstocks, while having a suitable content of active phase.

### SUBJECTS OF THE INVENTION

The invention relates to a catalyst for hydroconversion/hydrotreating of residue having an optimized pore distribution and an active phase co-mixed in a calcined alumina matrix.

The invention also relates to a preparation process for a catalyst suitable for hydroconversion/hydrotreating of residues by co-mixing the active phase with a particular alumina.

The invention finally relates to the use of the catalyst in hydrotreating processes, in particular hydrotreating of heavy feedstocks.

### SUMMARY OF THE INVENTION

The invention relates to a preparation process for a catalyst with a co-mixed active phase, comprising at least one metal of group VIB of the periodic table, optionally at least one metal of group VIII of the periodic table, optionally phosphorus and a predominantly alumina oxide matrix, comprising the following steps:
a) a first step of precipitation, in an aqueous reaction medium, of at least one basic precursor selected from sodium aluminate, potassium aluminate, ammonia, sodium hydroxide and potassium hydroxide and of at least one acidic precursor selected from aluminium sulphate, aluminium chloride, aluminium nitrate, sulphuric acid, hydrochloric acid and nitric acid, in which at least one of the basic or acidic precursors comprises aluminium, the relative flow rate of the acidic and basic precursors is selected so as to obtain a pH of the reaction medium comprised between 8.5 and 10.5 and the flow rate of the acidic and basic precursor or precursors containing aluminium is adjusted so as to obtain a degree of conversion of the first step comprised between 5 and 13%, the degree of conversion being defined as the proportion of alumina formed in Al₂O₃ equivalent during said first step of precipitation relative to the total quantity of alumina formed in Al₂O₃ equivalent at the end of step c) of the preparation process, said step taking place at a temperature comprised between 20 and 90° C. and for a duration comprised between 2 minutes and 30 minutes;
b) a step of heating the suspension at a temperature comprised between 40 and 90° C. for a duration comprised between 7 minutes and 45 minutes;
c) a second step of precipitation of the suspension obtained at the end of the heating step b) by adding to the suspension at least one basic precursor selected from sodium aluminate, potassium aluminate, ammonia, sodium hydroxide and potassium hydroxide and at least one acidic precursor selected from aluminium sulphate, aluminium chloride, aluminium nitrate, sulphuric acid, hydrochloric acid and nitric acid, in which at least one of the basic or acidic precursors comprises aluminium, the relative flow rate of the acidic and basic precursors is selected so as to obtain a pH of the reaction medium comprised between 8.5 and 10.5 and the flow rate of the acidic and basic precursor or precursors containing aluminium is adjusted so as to obtain a degree of conversion of the second step comprised between 87 and 95%, the degree of conversion being defined as the proportion of alumina formed in Al₂O₃ equivalent during said second precipitation step relative to the total quantity of alumina formed in Al₂O₃ equivalent at the end of step c) of the preparation process, said step taking place at a temperature comprised between 40 and 90° C. and for a duration comprised between 2 minutes and 50 minutes;
d) a step of filtration of the suspension obtained at the end of the second precipitation step c) in order to obtain an alumina gel;
e) a step of drying said alumina gel obtained in step d) in order to obtain a powder;
f) a step of heat treatment of the powder obtained at the end of step e) between 500 and 1000° C., for a duration comprised between 2 and 10 h, in the presence or absence of an air flow containing up to 60% by volume of water to in order obtain a calcined porous alumina oxide;
g) a step of mixing the calcined porous alumina oxide obtained with a solution of at least one metal precursor of the active phase in order to obtain a paste;
h) a step of forming the paste obtained;
i) a step of drying the formed paste at a temperature less than or equal to 200° C. in order to obtain a dried catalyst;
j) an optional step of heat treatment of the dried catalyst at a temperature comprised between 200 and 1000° C., in the presence or absence of water.

The degree of conversion of the first precipitation step a) is advantageously comprised between 6 and 12%.

The degree of conversion of the first precipitation step a) is very preferably comprised between 7 and 11%.

The acidic precursor is advantageously selected from aluminium sulphate, aluminium chloride and aluminium nitrate, preferably aluminium sulphate.

The basic precursor is advantageously selected from sodium aluminate and potassium aluminate, preferably sodium aluminate.

Preferably, in steps a), b), c) the aqueous reaction medium is water and said steps are carried out with stirring, in the absence of organic additive.

The invention also relates to a mesoporous and macroporous hydroconversion catalyst comprising:
a predominantly calcined alumina oxide matrix;
a hydrogenating-dehydrogenating active phase comprising at least one metal of group VIB of the periodic table, optionally at least one metal of group VIII of the periodic table, optionally phosphorus,

said active phase being at least partly co-mixed within said predominantly calcined alumina oxide matrix,

said catalyst having a specific surface area S_{BET} greater than 100 m²/g, a mesopore median diameter by volume comprised between 12 nm and 25 nm inclusive, a macropore median diameter by volume comprised between 50 and 250 nm inclusive, a mesopore volume as measured with a mercury intrusion porosimeter greater than or equal to 0.65 ml/g and a total pore volume measured by mercury porosimetry greater than or equal to 0.75 ml/g.

Preferably, said catalyst has a mesopore median diameter by volume determined with a mercury intrusion porosimeter comprised between 13 and 17 nm inclusive.

Preferably, said catalyst has a macropore volume comprised between 15 and 35% of the total pore volume.

Preferably, the mesopore volume is comprised between 0.65 and 0.75 ml/g.

Preferably, the catalyst does not have micropores.

Preferably, the content of group VIB metal is comprised between 2 and 10% by weight of trioxide at least of the group VIB metal relative to the total weight of the catalyst, the content of group VIII metal is comprised between 0.0 and 3.6% by weight of the oxide at least of the group VIII metal relative to the total weight of the catalyst, the content of the element phosphorus is comprised between 0 and 5% by weight of phosphorus pentoxide relative to the total weight of the catalyst.

The hydrogenating-dehydrogenating active phase may consist of molybdenum (Mo), or of nickel and molybdenum (NiMo), or of cobalt and molybdenum (CoMo).

The hydrogenating-dehydrogenating active phase preferably also comprises phosphorus.

Advantageously, the hydrogenating-dehydrogenating active phase is entirely co-mixed.

In an embodiment, a portion of the hydrogenating-dehydrogenating active phase may be impregnated on the predominantly alumina oxide matrix.

The invention also relates to a process for hydrotreating a heavy hydrocarbon feedstock selected from atmospheric residues, vacuum residues resulting from direct distillation, deasphalted oils, residues originating from conversion processes such as for example those originating from coking, from fixed-bed, ebullating-bed or moving-bed hydroconversion used alone or in a mixture, said hydrotreating process comprising bringing said feedstock into contact with hydrogen and a catalyst that can be prepared according to the invention or a catalyst as described above.

The process may be carried out partly in an ebullating bed at a temperature comprised between 320 and 450° C., under a hydrogen partial pressure comprised between 3 MPa and 30 MPa, at a space velocity advantageously comprised between 0.1 and 10 volumes of feedstock per volume of catalyst per hour, and with a ratio of gaseous hydrogen to liquid hydrocarbon feedstock advantageously comprised between 100 and 3000 normal cubic metres per cubic metre.

The process may be carried out at least partly in a fixed bed at a temperature comprised between 320° C. and 450° C., under a hydrogen partial pressure comprised between 3 MPa and 30 MPa, at a space velocity comprised between 0.05 and 5 volumes of feedstock per volume of catalyst per hour, and with a ratio of gaseous hydrogen to liquid hydrocarbon feedstock comprised between 200 and 5000 normal cubic metres per cubic metre.

Said process may be a process for hydrotreating a heavy hydrocarbon feedstock of the residues type in a fixed bed comprising at least:
a) a hydrodemetallization step
b) a hydrodesulphurization step
and said catalyst is used in at least one of said steps a) and b).

### DETAILED DESCRIPTION OF THE INVENTION

The applicant discovered that the co-mixing of an alumina originating from a particular gel prepared according to a preparation process described below with a metallic formulation containing at least one group VIB element, optionally at least one group VIII element and optionally the element phosphorus allows a catalyst to be obtained that has, simultaneously, a high total pore volume (greater than or equal to 0.75 ml/g), a high mesopore volume (greater than or equal to 0.65 ml/g), a high median mesopore diameter (comprised between 12 and 25 nm), a median macropore diameter comprised between 50 and 250 nm, but also active phase characteristics favourable to hydrotreating.

Moreover, in addition to reducing the number of steps and therefore the cost of manufacture, the benefit of co-mixing compared with impregnation is that it avoids any risk of partial clogging of the porosity of the support during deposition of the active phase and thus the occurrence of restriction problems.

As well as being able to be synthesized at lower cost, such a catalyst offers a significant gain in hydrodemetallization relative to the other co-mixed catalysts of the prior art, and therefore requires a lower operating temperature than the latter to achieve the same level of conversion of the metallated compounds. In particular employing said catalyst according to the invention at the start of the complete fixed-bed chain, i.e. a hydrodemetallization (HDM) section, then a hydrodesulphurization (HDS) section, the overall performance of the chain is improved.

Terminology and Techniques for Characterization

Hereinafter, dispersibility is defined as the weight of peptized alumina solid or gel that cannot be dispersed by centrifugation in a polypropylene tube at 3600 g for 3 min.

The catalyst of the present invention has a specific pore distribution, where the macropore and mesopore volumes are measured by mercury intrusion and the micropore volume is measured by nitrogen adsorption.

By “macropores” is meant pores the opening of which is greater than 50 nm.

By “mesopores” is meant pores the opening of which is comprised between 2 nm and 50 nm inclusive.

By “micropores” is meant pores the opening of which is less than 2 nm.

In the following disclosure of the invention, specific surface area means the BET specific surface area determined by nitrogen adsorption according to standard ASTM D 3663-78 based on the BRUNAUER-EMMETT-TELLER method described in the periodical “The Journal of the American Chemical Society”, 60, 309, (1938).

In the following disclosure of the invention, by total pore volume of the alumina or of the predominantly alumina matrix or of the catalyst is meant the volume measured with a mercury intrusion porosimeter according to standard ASTM D4284-83 at a maximum pressure of 4000 bar (400 MPa), using a surface tension of 484 dyne/cm and a contact angle of 140°. The wetting angle was taken equal to 140° following the recommendations in the work “Techniques de l'ingénieur, traité analyse et caractérisation” (Techniques of the engineer, a treatise on analysis and characterization), p. 1050-5, written by Jean Charpin and Bernard Rasneur.

In order to obtain greater accuracy, the value of the total pore volume in ml/g given in the following text corresponds to the value of the total mercury volume (total pore volume measured with a mercury intrusion porosimeter) in ml/g measured on the sample minus the value of the mercury volume in ml/g measured on the same sample for a pressure corresponding to 30 psi (about 0.2 MPa).

The volume of the macropores and mesopores is measured by mercury intrusion porosimetry according to standard ASTM D4284-83 at a maximum pressure of 4000 bar (400 MPa), using a surface tension of 484 dyne/cm and a contact angle of 140°.

The value starting from which the mercury fills all the intergranular voids is set at 0.2 MPa, and it is considered that beyond this, the mercury penetrates into the pores of the sample.

The macropore volume of the catalyst is defined as being the cumulative volume of mercury introduced at a pressure comprised between 0.2 MPa and 30 MPa, corresponding to the volume contained in the pores with apparent diameter greater than 50 nm.

The mesopore volume of the catalyst is defined as being the cumulative volume of mercury introduced at a pressure comprised between 30 MPa and 400 MPa, corresponding to the volume contained in the pores with apparent diameter comprised between 2 and 50 nm.

The volume of the micropores is measured by nitrogen porosimetry. Quantitative analysis of the microporosity is carried out on the basis of the “t” method (method of Lippens-De Boer, 1965), which corresponds to a transform of the initial adsorption isotherm as described in the work “Adsorption by powders and porous solids. Principles, methodology and applications” written by F. Rouquérol, J. Rouquérol and K. Sing, Academic Press, 1999.

The median mesopore diameter is also defined as being a diameter such that all the pores smaller than this diameter constitute 50% of the total mesopore volume determined with a mercury intrusion porosimeter.

The median macropore diameter is also defined as being a diameter such that all the pores smaller than this diameter constitute 50% of the total macropore volume determined with a mercury intrusion porosimeter.

Hereinafter, the groups of chemical elements are given according to the CAS classification (CRC Handbook of Chemistry and Physics, publisher CRC Press, editor in chief D. R. Lide, 81st edition, 2000-2001). For example, group VIII according to the CAS classification corresponds to the metals of columns 8, 9 and 10 according to the new IUPAC classification.

General Description of the Catalyst

The invention relates to a hydroconversion catalyst with a co-mixed active phase, comprising at least one metal of group VIB of the periodic table, optionally at least one metal of group VIII of the periodic table, optionally phosphorus and a predominantly calcined alumina oxide matrix, the preparation process thereof and the use thereof in a process for hydrotreating heavy hydrocarbon feedstocks such as petroleum residues (atmospheric or vacuum residues).

The catalyst according to the invention is in the form of a matrix predominantly comprising a calcined porous refractory oxide, within which the metals of the active phase are distributed.

The invention also relates to the preparation process for the catalyst, which is carried out by co-mixing a particular alumina with a metal solution of a formulation suitable for the metal target intended for the final catalyst.

The characteristics of the gel that led to production of the alumina, as well as the textural and active phase properties obtained, endow the catalyst according to the invention with its specific properties.

The group VIB metals are advantageously selected from molybdenum and tungsten, and preferably said group VIB metal is molybdenum.

The group VIII metals are advantageously selected from iron, nickel or cobalt and nickel or cobalt, or a combination of the two, will be preferred.

The respective quantities of group VIB metal and of group VIII metal are advantageously such that the atomic ratio of group VIII metal(s) to group VIB metal(s) (VIII:VIB) is comprised between 0.0:1 and 0.7:1, preferably between 0.1:1 and 0.6:1 and more preferably between 0.2:1 and 0.5:1. This ratio may in particular be adjusted depending on the type of feedstock and the process used.

The respective quantities of group VIB metal and of phosphorus are such that the atomic ratio of phosphorus to group VIB metal(s) (P/VIB) is comprised between 0.2:1 and 1.0:1, preferably between 0.4:1 and 0.9:1 and even more preferably between 0.5:1.0 and 0.85:1.

The content of group VIB metal is advantageously comprised between 2 and 10% by weight of trioxide at least of the group VIB metal relative to the total weight of the catalyst, preferably between 3 and 8%, and even more preferably between 4 and 7% by weight.

The content of group VIII metal is advantageously comprised between 0.0 and 3.6% by weight of the oxide at least of the group VIII metal relative to the total weight of the catalyst, preferably between 0.4 and 2.5% and even more preferably between 0.7 and 1.8% by weight.

The content of phosphorus element is advantageously comprised between 0.0 and 5% by weight of phosphorus pentoxide relative to the total weight of the catalyst, preferably between 0.6 and 3.5% by weight and even more preferably between 1.0 and 3.0% by weight.

The predominantly calcined alumina matrix of said catalyst according to the invention comprises a content of alumina greater than or equal to 90% and a silica content of at most 10% by weight in SiO₂ equivalent relative to the weight of the matrix, preferably a silica content below 5% by weight, very preferably a content less than 2% by weight.

The silica may be introduced, by any technique known to a person skilled in the art, during synthesis of the alumina gel or at the time of co-mixing.

Even more preferably, the alumina matrix contains nothing other than alumina.

Said catalyst with a co-mixed active phase according to the invention is generally presented in all the forms known to a person skilled in the art. Preferably, it consists of extrudates with a diameter generally comprised between 0.5 and 10 mm, preferably between 0.8 and 3.2 mm and very preferably between 1.0 and 2.5 mm. The latter may advantageously be in the form of cylindrical, trilobed or tetralobed extrudates. Preferably, its shape will be trilobed or tetralobed. The shape of the lobes can be adjusted by all the methods known from the prior art.

The co-mixed catalyst according to the invention has particular textural properties.

The catalyst according to the invention has a total pore volume (TPV) of at least 0.75 ml/g and preferably at least 0.80 ml/g. In a preferred embodiment, the catalyst has a total pore volume comprised between 0.80 and 1.05 ml/g.

The catalyst used according to the invention advantageously has a macropore volume, Vmacro or V_{50 nm}, defined as the volume of the pores with a diameter greater than 50 nm, comprised between 15 and 35% of the total pore volume, and preferably between 15 and 30% of the total pore volume. In a much preferred embodiment, the macropore volume represents between 20 and 30% of the total pore volume.

The mesopore volume (Vmeso) of the catalyst is at least 0.65 ml/g, preferably comprised between 0.65 and 0.80 ml/g. In a preferred embodiment, the mesopore volume of the catalyst is comprised between 0.65 ml/g and 0.75 ml/g.

The median mesopore diameter (Dₚₘₑₛₒ) is comprised between 12 nm and 25 nm inclusive, and preferably between 12 and 18 nm inclusive. Very preferably, the median mesopore diameter is between 13 and 17 nm inclusive.

The catalyst advantageously has a median macropore diameter (D_{pmacro}) comprised between 50 and 250 nm, preferably between 80 and 200 nm, even more preferably between 80 and 150 nm. Very preferably, the median macropore diameter is comprised between 90 and 130 nm.

The catalyst according to the present invention has a BET specific surface area (S_{BET}) of at least 100 m²/g, preferably of at least 120 m²/g and even more preferably comprised between 150 and 250 m²/g.

Preferably, the catalyst has a low microporosity, and very preferably no microporosity is detectable with nitrogen porosimetry.

If necessary, it is possible to increase the metal content by introducing a second portion of active phase by impregnation on the catalyst already co-mixed with a first portion of the active phase.

It is important to emphasize that the catalyst according to the invention differs structurally from a catalyst obtained by simple impregnation of a metal precursor on an alumina support in which the alumina forms the support and the active phase is introduced into the pores of this support. Without wishing to be bound by any theory, it appears that the a preparation process for the catalyst according to the invention by co-mixing a particular porous alumina oxide with one or more metal precursors makes it possible to obtain a composite in which the metals and the alumina are intimately mixed, thus forming the actual structure of the catalyst with a porosity and a content of active phase with the desired reactions.

A preparation Process for the Catalyst According to the Invention

Main Steps

The catalyst according to the invention is prepared by the co-mixing of a calcined porous alumina oxide obtained from a specific alumina gel and metal precursor(s).

The a preparation process for the catalyst according to the invention comprises the following steps:

a) to e): Synthesis of the precursor gel of the porous oxide

f) Heat treatment of the powder obtained at the end of step e)

g) Co-mixing of the porous oxide obtained with at least one precursor of the active phase

h) Forming of the paste obtained by mixing, for example by extrusion

i) Drying the formed paste obtained

j) Optional heat treatment (preferably under dry air)

The solid obtained at the end of steps a) to f) undergoes a step g) of co-mixing. It is then formed in a step h), and then it can simply be dried at a temperature less than or equal to 200° C. (step i) or it can be dried, and then subjected to a new heat treatment of calcination in an optional step j).

Before it is used in a hydrotreating process, the catalyst is usually subjected to a final step of sulphurization. This step consists of activating the catalyst by transforming, at least partly, the oxide phase in a sulpho-reducing medium. This treatment of activation by sulphurization is familiar to a person skilled in the art and may be carried out by any method already known and already described in the literature. A conventional method of sulphurization familiar to a person skilled in the art consists of heating the mixture of solids under a flow of a mixture of hydrogen and hydrogen sulphide or under a flow of a mixture of hydrogen and hydrocarbons containing sulphur-containing molecules at a temperature comprised between 150 and 800° C., preferably comprised between 250 and 600° C., generally in a traversed bed reaction zone.

Detailed Description of the Preparation Process

The catalyst with a co-mixed active phase according to the invention is prepared from a specific alumina gel, which is dried and calcined before co-mixing with the active phase, and is then formed.

The steps of preparation of the alumina gel implemented during preparation of the catalyst according to the invention are detailed below.

According to the invention, said a preparation process for alumina gel comprises a first precipitation step a), a heating step b), a second precipitation step c), a filtration step d), and a drying step e).

The degree of conversion for each of the precipitation steps is defined as the proportion of alumina formed in Al₂O₃ equivalent during said first or second precipitation step relative to the total quantity of alumina formed in Al₂O₃ equivalent at the end of the two precipitation steps and more generally at the end of the steps of preparation of the alumina gel and in particular at the end of step c) of the preparation process according to the invention.

Step a): First Precipitation

This step consists of contacting, in an aqueous reaction medium, at least one basic precursor selected from sodium aluminate, potassium aluminate, ammonia, sodium hydroxide and potassium hydroxide and at least one acidic precursor selected from aluminium sulphate, aluminium chloride, aluminium nitrate, sulphuric acid, hydrochloric acid, and nitric acid, in which at least one of the basic or acidic precursors comprises aluminium, the relative flow rate of the acidic and basic precursors is selected so as to obtain a pH of the reaction medium comprised between 8.5 and 10.5 and the flow rate of the acidic and basic precursor or precursors containing aluminium is adjusted so as to obtain a degree of conversion of the first step comprised between 5 and 13%, the degree of conversion being defined as the proportion of alumina formed in Al₂O₃ equivalent during said precipitation step a) relative to the total quantity of alumina formed in Al₂O₃ equivalent at the end of step c), said step taking place at a temperature comprised between 20 and 90° C., and for a duration comprised between 2 minutes and 30 minutes.

Mixing at least one basic precursor and at least one acidic precursor in the aqueous reaction medium requires that at least one of the acidic or basic precursors comprises aluminium. It is also possible that at least two of the basic and acidic precursors comprise aluminium.

The basic precursors comprising aluminium are sodium aluminate and potassium aluminate. The basic precursor preferred is sodium aluminate.

The acidic precursors comprising aluminium are aluminium sulphate, aluminium chloride and aluminium nitrate. The acidic precursor preferred is aluminium sulphate.

Preferably, the aqueous reaction medium is water.

Preferably, said step a) operates with stirring.

Preferably, said step a) is carried out in the absence of organic additive.

The acidic and basic precursors, whether or not they contain aluminium, are mixed, preferably in solution, in the aqueous reaction medium, in proportions such that the pH of the resultant suspension is comprised between 8.5 and 10.5.

According to the invention, the acidic alumina precursors and the basic alumina precursors may be used alone or in a mixture in the precipitation step.

According to the invention, the relative flow rate of the acidic and basic precursors, whether or not they contain aluminium, is selected so as to obtain a pH of the reaction medium comprised between 8.5 and 10.5.

In the preferred case where the basic and acidic precursors are respectively sodium aluminate and aluminium sulphate, the mass ratio of said basic precursor to said acidic precursor is advantageously comprised between 1.60 and 2.05.

For the other basic and acidic precursors, whether or not they contain aluminium, the base/acid mass ratios are established from a curve of neutralization of the base by the acid. Such a curve is easily obtained by a person skilled in the art.

Preferably, said precipitation step a) is carried out at a pH comprised between 8.5 and 10.0 and very preferably between 8.7 and 9.9.

According to the invention, the first precipitation step a) is carried out at a temperature comprised between 20 and 90° C., preferably between 20 and 70° C. and more preferably between 30 and 50° C.

According to the invention, the first precipitation step a) is carried out for a duration comprised between 2 and 30 minutes, preferably between 5 and 20 minutes, and very preferably between 5 and 15 minutes.

According to the invention, the degree of conversion of said first precipitation step a) is comprised between 5 and 13%, preferably between 6 and 12% and very preferably between 7 and 11%. The acidic and basic precursors containing aluminium are therefore introduced in quantities allowing a suspension to be obtained containing the desired quantity of alumina, as a function of the final concentration of alumina to be achieved. In particular, said step a) makes it possible to obtain from 5 to 13% by weight of alumina relative to the total quantity of alumina formed in Al₂O₃ equivalent at the end of step c) of the preparation process.

Step b): Heating

According to the invention, said preparation process comprises a step b) of heating the suspension obtained at the end of the first precipitation step a).

According to the invention, before the second precipitation step is carried out, a step of heating the suspension obtained at the end of precipitation step a) is carried out between the two precipitation steps. Said step of heating the suspension obtained at the end of step a), carried out between said first precipitation step a) and second precipitation step c), is carried out at a temperature comprised between 40 and 90° C., preferably between 40 and 80° C., very preferably between 40 and 70° C. and even more preferably between 40 and 65° C.

Said heating step is carried out for a duration comprised between 7 and 45 minutes and preferably between 7 and 35 minutes.

Said heating step is advantageously carried out according to any methods of heating known to a person skilled in the art.

Step c): Second Precipitation

According to the invention, said preparation process comprises a second step of precipitation of the heated suspension obtained at the end of the heating step b), said second step being carried out by adding, to said suspension, at least one basic precursor selected from sodium aluminate, potassium aluminate, ammonia, sodium hydroxide and potassium hydroxide and at least one acidic precursor selected from aluminium sulphate, aluminium chloride, aluminium nitrate, sulphuric acid, hydrochloric acid, and nitric acid, in which at least one of the basic or acidic precursors comprises aluminium, the relative flow rate of the acidic and basic precursors is selected so as to obtain a pH of the reaction medium comprised between 8.5 and 10.5 and the flow rate of the acidic and basic precursor or precursors containing aluminium is adjusted so as to obtain a degree of conversion of the second step comprised between 87 and 95%, the degree of conversion being defined as the proportion of alumina formed in Al₂O₃ equivalent during said second precipitation step relative to the total quantity of alumina formed in Al₂O₃ equivalent at the end of step c) of the preparation process, said step taking place at a temperature comprised between 40 and 90° C., and for a time of comprised between 2 minutes and 50 minutes.

The basic and acidic precursor or precursors are added in said second step of co-precipitation in aqueous solution.

Just as in the first precipitation step a), the addition of at least one basic precursor and of at least one acidic precursor to the heated suspension requires that at least one of the basic or acidic precursors comprises aluminium. It is also possible that at least two of the basic and acidic precursors comprise aluminium.

The basic precursors comprising aluminium are sodium aluminate and potassium aluminate. The basic precursor preferred is sodium aluminate.

The acidic precursors comprising aluminium are aluminium sulphate, aluminium chloride and aluminium nitrate. The acidic precursor preferred is aluminium sulphate.

Preferably, said second precipitation step takes place with stirring.

Preferably, said second step is carried out in the absence of organic additive.

The acidic and basic precursors, whether or not they contain aluminium, are mixed, preferably in solution, in the suspension, in proportions such that the pH of the resultant suspension is comprised between 8.5 and 10.5.

Just as in precipitation step a), the relative flow rate of the acidic and basic precursors, whether or not they contain aluminium, is selected so as to obtain a pH of the reaction medium comprised between 8.5 and 10.5, preferably comprised between 8.5 and 10, even more preferably comprised between 8.7 and 9.9.

In the preferred case where the basic and acidic precursors are respectively sodium aluminate and aluminium sulphate, the mass ratio of said basic precursor to said acidic precursor is advantageously comprised between 1.60 and 2.05.

For the other basic and acidic precursors, whether or not they contain aluminium, the base/acid mass ratios are established from a curve of neutralization of the base by the acid. Such a curve is easily obtained by a person skilled in the art.

The aluminium precursors are also mixed in quantities allowing a suspension to be obtained containing the desired quantity of alumina, as a function of the final concentration of alumina to be achieved. In particular, said second precipitation step makes it possible to obtain 87 to 95% by weight of alumina relative to the total quantity of alumina formed in Al₂O₃ equivalent at the end of the two precipitation steps.

Just as in precipitation step a), it is the flow rate of the acidic and basic precursor or precursors containing aluminium that is controlled so as to obtain a degree of conversion of the second step comprised between 87 and 95%, preferably between 88 and 94%, very preferably between 89 and 93%, the degree of conversion being defined as the proportion of alumina formed in Al₂O₃ equivalent during said second precipitation step relative to the total quantity of alumina formed in Al₂O₃ equivalent at the end of step c) of the preparation process.

Thus, depending on the concentration of alumina required at the end of the precipitation steps, preferably comprised between 20 and 100 g/l, the quantities of aluminium that have to be supplied by the acidic and/or basic precursors are calculated and the flow rate of the precursors is adjusted as a function of the concentration of said aluminium precursors that are added, of the quantity of water added to the reaction medium and of the degree of conversion required for each of the precipitation steps.

Just as in precipitation step a), the flow rates of the acidic and/or basic precursor or precursors containing aluminium depend on the size of the reactor used and thus on the quantity of water added to the reaction medium.

By way of example, if when working in a 3-litre reactor, 1 l of alumina suspension with a final Al₂O₃ concentration of 50 g/l is sought, with a targeted degree of conversion of 10% for the first precipitation step, 10% of the total alumina must be supplied during precipitation step a). The alumina precursors are sodium aluminate at an Al₂O₃ concentration of 155 g/l and aluminium sulphate at an Al₂O₃ concentration of 102 g/l. The pH of precipitation in the first step is set at 9.5 and the pH of the second step at 9. The quantity of water added to the reactor is 620 ml.

For the first precipitation step a) operating at 30° C. for 8 minutes, the flow rate of aluminium sulphate must be 2.1 ml/min and the flow rate of sodium aluminate is 2.6 ml/min. The mass ratio of sodium aluminate to aluminium sulphate is therefore 1.91.

For the second precipitation step, operating at 70° C., for 30 minutes, the flow rate of aluminium sulphate must be 5.2 ml/min and the flow rate of sodium aluminate is 6.3 ml/min. The mass ratio of sodium aluminate to aluminium sulphate is therefore 1.84.

Preferably, the second precipitation step is carried out at a temperature comprised between 40 and 80° C., preferably between 45 and 70° C. and very preferably between 50 and 70° C.

Preferably, the second precipitation step is carried out for a duration comprised between 5 and 45 minutes, and preferably from 7 to 40 minutes.

The second precipitation step generally makes it possible to obtain an alumina suspension having a concentration of Al₂O₃ comprised between 20 and 100 g/l, preferably between 20 and 80 g/l, and more preferably between 20 and 50 g/l.

Step d): Filtration

The preparation process for alumina according to the invention also comprises a step of filtration of the suspension obtained at the end of the second precipitation step c). Said filtration step is carried out by the methods known to a person skilled in the art.

The filterability of the suspension obtained at the end of the two precipitation steps is improved by the low dispersibility of the alumina gel obtained, which makes it possible to improve the productivity of the process according to the invention as well as allowing extrapolation of the process to the industrial level.

Said filtration step is advantageously followed by at least one washing step, preferably with water, and preferably by one to three washing steps, with an quantity of water equal to the quantity of precipitate filtered.

The chain of steps of first precipitation a), heating b) and second precipitation c) and the filtration step d) makes it possible to obtain a specific alumina gel having a degree of dispersibility below 15%, preferably comprised between 5 and 15% and more preferably comprised between 6 and 14%, very preferably comprised between 7 and 13%, and even more preferably comprised between 7 and 10% and a crystallite size comprised between 1 and 35 nm and preferably comprised between 2 and 35 nm.

The alumina gel obtained also advantageously has a sulphur content, measured by the X-ray fluorescence method, comprised between 0.001 and 2% by weight and preferably comprised between 0.01 and 0.2% by weight and a sodium content, measured by ICP-MS or inductively-coupled plasma mass spectrometry, comprised between 0.001 and 2% by weight, and preferably comprised between 0.01 and 0.1% by weight, the percentages by weight being expressed relative to the total weight of alumina gel.

In particular, alumina gel or boehmite in the form of powder according to the invention is composed of crystallites the size of which, obtained from the Scherrer formula using X-ray diffraction in the [020] and [120] crystallographic directions, are respectively comprised between 2 and 20 nm and between 2 and 35 nm.

Preferably, the alumina gel according to the invention has a crystallite size in the [020] crystallographic direction comprised between 1 and 15 nm and a crystallite size in the [120] crystallographic direction comprised between 1 and 35 nm.

X-ray diffraction on the alumina gels or boehmites was carried out using the standard powder method using a diffractometer.

The Scherrer formula is a formula used in X-ray diffraction on powders or polycrystalline samples that relates the half-height width of the diffraction peaks to the size of the crystallites. It is described in detail in the reference: Appl. Cryst. (1978). 11, 102-113 “Scherrer after sixty years: A survey and some new results in the determination of crystallite size”, J. I. Langford and A. J. C. Wilson.

The low degree of dispersibility of the gel thus prepared can facilitate the step of forming of said gel by all the methods known to a person skilled in the art and in particular by mixing-extrusion, by granulation and by the so-called oil drop technique.

Step e): Drying the Alumina Gel

According to the invention, the alumina gel obtained at the end of the second precipitation step c), followed by a filtration step d), is dried in a drying step e) in order to obtain a powder, said drying step being carried out by drying, for example by drying at a temperature comprised between 20 and 200° C. and for a duration comprised between 8 h and 15 h, or by spray-drying or by any other drying technique known to a person skilled in the art.

In the case when said drying step e) is carried out by spray-drying, the cake obtained at the end of the second precipitation step, followed by a filtration step, is resuspended. Said suspension is then sprayed in fine droplets, in a vertical cylindrical chamber in contact with a flow of hot air in order to evaporate the water in accordance with the principle that is well known to a person skilled in the art. The powder obtained is entrained by the heat flow to a cyclone or a bag filter which will separate the air from the powder.

Preferably, in the case when said drying step e) is carried out by spray-drying, the spray-drying is carried out according to the operating procedure described in the publication Asep Bayu Dani Nandiyanto, Kikuo Okuyama, Advanced Powder Technology, 22, 1-19, 2011.

Step f): Heat Treatment of the Powder Obtained at the End of Step e)

According to the invention, the powder obtained at the end of the drying step e) is subjected to a step f) of heat treatment at a temperature comprised between 500 and 1000° C., for a duration comprised between 2 and 10 h, in the presence or absence of an air flow containing up to 60% by volume of water.

Preferably, said step f) of heat treatment takes place at a temperature comprised between 540° C. and 850° C.

Preferably, said step f) of heat treatment takes place for a duration comprised between 2 h and 10 h.

Said step f) of heat treatment allows transition of the boehmite to the final alumina.

The step of heat treatment may be preceded by drying at a temperature comprised between 50° C. and 120° C., according to any technique known to a person skilled in the art.

According to the invention, the powder obtained at the end of the drying step e), after the heat treatment in a step f), is co-mixed with the metal precursor or precursors of the active phase, in a step g) of co-mixing for bringing the solution or solutions containing the active phase into contact with the powder, and then forming the resultant material in order to obtain the catalyst in a step h).

Step a): Co-Mixing Step

In this step, the calcined porous alumina oxide from step f) is mixed in the presence of the active phase in the form of solution of the precursors of the metal or metals selected from the group VIB elements, optionally the group VIII elements and optionally phosphorus.

The active phase is supplied by one or more solutions containing at least one group VIB metal, optionally at least one group VIII metal and optionally the element phosphorus. Said solution(s) may be aqueous, consisting of an organic solvent or of a mixture of water and at least one organic solvent (for example ethanol or toluene). Preferably, the solution is aqueous-organic and even more preferably aqueous-alcoholic. The pH of this solution will be modifiable by the optional addition of an acid.

The compounds that may be added to the solution as sources of group VIII elements advantageously include: citrates, oxalates, carbonates, hydroxycarbonates, hydroxides, phosphates, sulphates, aluminates, molybdates, tungstates, oxides, nitrates, halides, for example chlorides, fluorides, bromides, acetates, or any mixture of the compounds stated here.

The sources of the group VIB element that are well known to a person skilled in the art advantageously include, for example for molybdenum and tungsten: the oxides, hydroxides, molybdic and tungstic acids and salts thereof, in particular the ammonium salts, ammonium heptamolybdate, ammonium tungstate, phosphomolybdic acid, phosphotungstic acid and salts thereof. The oxides or the ammonium salts such as ammonium molybdate, ammonium heptamolybdate or ammonium tungstate are preferably used.

The preferred source of phosphorus is orthophosphoric acid, but its salts and esters such as the alkaline phosphates, ammonium phosphate, gallium phosphate or alkyl phosphates are also suitable. The phosphorous acids, for example hypophosphorous acid, phosphomolybdic acid and salts thereof, phosphotungstic acid and salts thereof may be used advantageously.

An additive, for example a chelating agent of an organic nature, may advantageously be added to the solution if this is deemed necessary by a person skilled in the art.

Any other element, for example silica in the form of a solution or emulsion of a silicic precursor, may be introduced into the mixing tank at the time of this step.

The co-mixing advantageously takes place in a mixer, for example a mixer of the “Brabender” type that is well known to a person skilled in the art. The porous alumina oxide in the form of calcined powder obtained in step f) and one or more additives or other optional elements are placed in the tank of the mixer. Then, the solution of metal precursors, for example nickel and molybdenum, and optionally deionized water are added by syringe or by any other means over a period of a few minutes, typically about 2 minutes at a given mixing speed. After obtaining a paste, mixing may be maintained for some minutes, for example about 15 minutes at 50 rpm.

Step h): Forming

The paste obtained at the end of the co-mixing step g) is then formed by any technique known to a person skilled in the art, for example the methods of forming by extrusion, by pelletizing, by the oil drop method, or by granulation on a rotating plate.

Preferably, said support used according to the invention is formed by extrusion in the form of extrudates generally with a diameter comprised between 0.5 and 10 mm and preferably between 0.8 and 3.2 mm. In a preferred embodiment, it will consist of trilobed or tetralobed extrudates with a size comprised between 1.0 and 2.5 mm in diameter.

Very preferably, said co-mixing step g) and said forming step h) are combined in a single step of mixing-extrusion. In this case, the paste obtained at the end of mixing may be fed into a ram extruder through a die of the desired diameter, typically between 0.5 and 10 mm.

Step i): Drying the Formed Paste

According to the invention, the catalyst obtained at the end of the co-mixing step g) and the forming step h) undergoes drying i) at a temperature less than or equal to 200° C., preferably less than 150° C. by any technique known to a person skilled in the art, for a time typically comprised between 2 and 12 h.

Step j): Thermal or Hydrothermal Treatment

The catalyst thus dried may then undergo a supplementary step of thermal or hydrothermal treatment j) at a temperature comprised between 200 and 1000° C., preferably between 300 and 800° C. and even more preferably between 350 and 550° C., for a duration typically comprised between 2 and 10 h, in the presence or absence of an air flow containing up to 60% by volume of water. Several combined cycles of thermal or hydrothermal treatments may be carried out.

In the case where the catalyst does not undergo a supplementary step of thermal or hydrothermal treatment, the catalyst is only advantageously dried in step i).

In the case where water is to be added, contact with steam may take place at atmospheric pressure (steaming) or at autogenous pressure (autoclaving). In the case of steaming, the water content is preferably comprised between 150 and 900 grams per kilogram of dry air, and even more preferably between 250 and 650 grams per kilogram of dry air.

According to the invention, addition of some or all of the aforementioned metals may be envisaged during co-mixing of the metal solution(s) with the calcined porous alumina oxide.

In an embodiment, in order to increase the total content of active phase on the co-mixed catalyst, a proportion of the metals may be introduced by impregnation of said catalyst from step i) or j), according to any method known to a person skilled in the art, the commonest being dry impregnation.

In another embodiment, the whole of the metallic phase is introduced during preparation by co-mixing of the porous alumina oxide and no additional impregnation step will therefore be necessary. Preferably, the active phase of the catalyst is co-mixed completely in the calcined porous alumina oxide.

Description of the Process of Using the Catalyst According to the Invention

The catalyst according to the invention may be employed in hydrotreating processes for converting heavy hydrocarbon feedstocks, containing sulphur impurities and metallic impurities. One desired objective of using the catalysts of the present invention relates to improvement in performance, in particular in hydrodemetallization and hydrodesulphurization, while improving the ease of preparation relative to the known catalysts of the prior art. The catalyst according to the invention makes it possible to improve performance in hydrodemetallization and hydrodeasphalting relative to conventional catalysts, while displaying considerable stability over time.

In general, the hydrotreating processes for converting heavy hydrocarbon feedstocks, containing sulphur impurities and metallic impurities, take place at a temperature comprised between 320 and 450° C., under a hydrogen partial pressure comprised between 3 MPa and 30 MPa, at a space velocity advantageously comprised between 0.05 and 10 volumes of feedstock per volume of catalyst per hour, and with a ratio of gaseous hydrogen to liquid hydrocarbon feedstock advantageously comprised between 100 and 5000 normal cubic metres per cubic metre.

Feedstocks

The feedstocks treated in the process according to the invention are advantageously selected from atmospheric residues, vacuum residues resulting from direct distillation, deasphalted oils, residues from conversion processes such as for example those originating from coking, from fixed-bed, ebullating-bed, or moving-bed hydroconversion, used alone or mixed. These feedstocks may advantageously be used as they are or else diluted with a hydrocarbon fraction or a mixture of hydrocarbon fractions that may be selected from the products obtained from the FCC process, a light cycle oil (LCO), a heavy cycle oil (HCO), a decanted oil (DO), a slurry, or may result from distillation, the gas oil fractions in particular those obtained by vacuum distillation called VGO (vacuum gas oil). The heavy feedstocks may thus advantageously comprise cuts originating from coal liquefaction, aromatic extracts, or any other hydrocarbon cut.

Said heavy feedstocks generally have more than 1% by weight of molecules having a boiling point greater than 500° C., a Ni+V metals content greater than 1 ppm by weight, preferably greater than 20 ppm by weight, very preferably greater than 50 ppm by weight, a content of asphaltenes, precipitated from heptane, greater than 0.05% by weight, preferably greater than 1% by weight, very preferably greater than 2%.

The heavy feedstocks may advantageously also be mixed with coal in powder form, this mixture generally being called slurry. These feedstocks may advantageously be by-products originating from coal conversion, mixed again with fresh coal. The content of coal in the heavy feedstock is generally and preferably a′A ratio (oil/coal) and may advantageously vary widely between 0.1 and 1. The coal may contain lignite, it may be a subbituminous coal, or else bituminous. Any other type of coal is suitable for use of the invention, either in fixed-bed reactors or in reactors with ebullating bed operation.

Using the Catalyst According to the Invention

According to the invention, the catalyst with a co-mixed active phase is preferably used in the first catalyst beds of a process comprising successively at least one step of hydrodemetallization and at least one step of hydrodesulphurization. The process according to the invention is advantageously implemented in one to ten successive reactors, and the catalyst or catalysts according to the invention may advantageously be loaded into one or more reactors and/or into some or all of the reactors.

In a preferred embodiment, switchable reactors, i.e. reactors operating alternately, in which hydrodemetallization catalysts according to the invention may preferably be utilized, may be used upstream of the unit. In this preferred embodiment, the switchable reactors are then followed by reactors in series, in which hydrodesulphurization catalysts are utilized, which may be prepared by any method known to a person skilled in the art.

In a very preferred embodiment, two switchable reactors are used upstream of the unit, advantageously for hydrodemetallization and containing one or more catalysts according to the invention. They are followed advantageously by one to four reactors in series, advantageously used for hydrodesulphurization.

The process according to the invention may advantageously be implemented in a fixed bed with the objective of removing the metals and sulphur and of lowering the average boiling point of the hydrocarbons. In the case where the process according to the invention is implemented in a fixed bed, the operating temperature is advantageously comprised between 320° C. and 450° C., preferably 350° C. to 410° C., under a hydrogen partial pressure advantageously comprised between 3 MPa and 30 MPa, preferably between 10 and 20 MPa, at a space velocity advantageously comprised between 0.05 and 5 volumes of feedstock per volume of catalyst per hour, and with a ratio of gaseous hydrogen to liquid hydrocarbon feedstock advantageously comprised between 200 and 5000 normal cubic metres per cubic metre, preferably 500 to 1500 normal cubic metres per cubic metre.

The process according to the invention may also advantageously be implemented partly in an ebullating bed on the same feedstocks. In the case when the process according to the invention is implemented in an ebullating bed, the catalyst is advantageously utilized at a temperature comprised between 320 and 450° C., under a hydrogen partial pressure advantageously comprised between 3 MPa and 30 MPa, preferably between 10 and 20 MPa, at a space velocity advantageously comprised between 0.1 and 10 volumes of feedstock per volume of catalyst per hour, preferably between 0.5 and 2 volumes of feedstock per volume of catalyst per hour, and with a ratio of gaseous hydrogen to liquid hydrocarbon feedstock advantageously comprised between 100 and 3000 normal cubic metres per cubic metre, preferably between 200 and 1200 normal cubic metres per cubic metre.

According to a preferred embodiment, the process according to the invention is carried out in a fixed bed.

Before being utilized in the process according to the invention, the catalysts of the present invention are preferably subjected to a sulphurization treatment making it possible to transform, at least partly, the metallic species to sulphide before they are brought into contact with the feedstock to be treated. This treatment of activation by sulphurization is well known to a person skilled in the art and may be carried out by any method already known and already described in the literature. A conventional method of sulphurization well known to a person skilled in the art consists of heating the mixture of solids under a flow of a mixture of hydrogen and hydrogen sulphide or under a flow of a mixture of hydrogen and hydrocarbons containing sulphur-containing molecules at a temperature comprised between 150 and 800° C., preferably between 250 and 600° C., generally in a traversed bed reaction zone.

The sulphurization treatment may be carried out ex situ (before introducing the catalyst into the hydrotreating/hydroconversion reactor) or in situ by means of an organosulphur agent that is a precursor of H₂S, for example DMDS (dimethyl disulphide).

The following examples illustrate the invention but without however limiting its scope.

### EXAMPLES

### Example 1

### Preparation of the Metal Solutions A, B

Solutions A and B used for preparing the catalysts A1, B1, A2, A3 were prepared by dissolving the precursors of the following phases MoO₃, Ni(OH)₂, H₃PO₄ in water. All of these precursors are obtained from Sigma-Aldrich®. The concentration of elements in the various solutions is shown in the following table.

TABLE 1
Molar concentration of the aqueous solutions
prepared (expressed in mol/l)

| | | | | Ni/Mo | P/Mo |
|---|---|---|---|---|---|
| Catalyst | Mo | Ni | P | mol/mol | mol/mol |
| A | 0.49 | 0.23 | 0.27 | 0.47 | 0.55 |
| B | 0.68 | 0.31 | 0.36 | 0.45 | 0.53 |

### Example 2

### Preparation of the Co-Mixed Catalysts A1, B1, According to the Invention

Synthesis of an alumina Al(A1) according to the invention is carried out in a 5 L reactor in 3 steps.

The concentration of the precursors is as follows: aluminium sulphate Al₂(SO₄)₃ at 102 g/L as Al₂O₃ and sodium aluminate NaAlO₂ at 155 g/L as Al₂O₃.

The alumina Al(A1) used according to the invention is manufactured according to the following steps:

a) A first co-precipitation of aluminium sulphate Al₂(SO₄)₃ and sodium aluminate NaAlO₂ at 30° C. and pH=9.1 over 8 min: the degree of conversion is 10%. The degree of conversion corresponds to the proportion of alumina formed during the first step, i.e. a final concentration of alumina at 45 g/l. If working in a 5-litre reactor and aiming for 4 l of alumina suspension with a final concentration of Al₂O₃ of 45 g/l, with a targeted degree of conversion of 10% for the first precipitation step, 10% of the total alumina must be supplied during precipitation step a). The pH of precipitation in the first step is set at 9.1 and the pH of precipitation in the second step at 9.1. The quantity of water initially present in the reactor is 1330 ml.

For the first precipitation step a) operating at 30° C. for 8 minutes, the flow rate of aluminium sulphate must be 7.6 ml/min, the flow rate of sodium aluminate is 9.1 ml/min and the flow rate of water is 24.6 ml/min. The mass ratio of sodium aluminate to aluminium sulphate is therefore 1.91.

b) A temperature rise from 30 to 70° C. over 20 to 30 min;

c) A second co-precipitation of aluminium sulphate Al₂(SO₄)₃ and sodium aluminate NaAlO₂ at 70° C. and pH=9.1 over 30 min, with a degree of conversion of 90%; for the second precipitation step operating at 70° C. for 30 minutes, the flow rate of aluminium sulphate must be 18.5 ml/min, the flow rate of sodium aluminate is 29 ml/min and the flow rate of water is 33.8 ml/min. The mass ratio of sodium aluminate to aluminium sulphate is therefore 1.84.

d) Filtration by displacement on a device of the Buchner P4 frit type and washing 3 times with 5 L of distilled water at 70° C.;

e) Drying overnight at 120° C.;

f) Calcination of the powder at 750° C.

The synthesis of an alumina Al(B1) according to the invention is carried out in a 5-litre reactor in 3 steps.

The concentration of the precursors is as follows: aluminium sulphate Al₂(SO₄)₃ at 102 g/l as Al₂O₃ and sodium aluminate NaAl NaAlO₂ at 155 g/l as Al₂O₃.

The alumina Al(B1) according to the invention is manufactured according to the following steps:

a) A first co-precipitation of aluminium sulphate Al₂(SO₄)₃ and sodium aluminate NaAlO₂ at 30° C. and pH=9.1 over 8 min: the degree of conversion is 8%. The degree of conversion corresponds to the proportion of alumina formed during the first step, i.e. a final concentration of alumina at 45 g/l. If working in a 5-litre reactor and aiming for 4 l of alumina suspension of final Al₂O₃ concentration of 45 g/l, with a targeted degree of conversion of 8% for the first precipitation step, 8% of the total alumina must be supplied during precipitation step a). The pH of precipitation in the first step is set at 9.1 and the pH of precipitation in the second step at 9.1. The quantity of water present initially in the reactor is 1330 ml.

For the first precipitation step a) operating at 30° C. for 8 minutes, the flow rate of aluminium sulphate must be 6.1 ml/min, the flow rate of sodium aluminate is 7.6 ml/min and the flow rate of water is 69.7 ml/min. The mass ratio of sodium aluminate to aluminium sulphate is therefore 1.91.

b) A temperature rise from 30 to 70° C. over 20 to 30 min;

c) A second co-precipitation of aluminium sulphate Al₂(SO₄)₃ and sodium aluminate NaAlO₂ at 70° C. and pH=9.1 over 30 min, with a degree of conversion of 92%; for the second precipitation step, operating at 70° C., for 30 minutes, the flow rate of aluminium sulphate must be 19 ml/min, the flow rate of sodium aluminate is 23 ml/min and the flow rate of water is 24.7 ml/min. The mass ratio of sodium aluminate to aluminium sulphate is therefore 1.84.

d) Filtration by displacement on a device of the Buchner P4 frit type and washing 3 times with 5 l of distilled water;

e) Drying overnight at 120° C.;

f) Calcination of the powder at 750° C.

The impregnating solutions A and B were mixed respectively in the presence of the aluminas Al(A1) and Al(B1) prepared above for preparing the catalysts A1 and B1.

Co-mixing takes place in a “Brabender” mixer with a tank of 80 cm³ and a mixing speed of 30 rpm. The alumina powder is placed in the tank of the mixer. Then the MoNi(P) solution is added by syringe over about 2 minutes at 15 rpm. Mixing is maintained for 15 minutes after obtaining a paste at 50 rpm. The paste thus obtained is introduced into the MTS capillary rheometer through a 2.1-mm die at 10 mm/min. The extrudates thus obtained are then dried overnight in a stove at 80° C., and then calcined for 2 h under air (1 L/h/g) in a tubular furnace at 400° C.

The catalysts thus obtained A1 and B1 have the characteristics presented in Table 2 below.

TABLE 2
Properties of the co-mixed catalysts E, A1, B1, A2, A3

| Catalyst | E | A1 | B1 | A2 | A3 |
|---|---|---|---|---|---|
| Objective of preparation | comparative | according to the | | comparative | comparative |
| | | invention | | | |
| State of alumina precursor | calcined | calcined | calcined | calcined | dried |

| | | |
|---|---|---|
| Manner of introduction of the metals | Dry impregnation | ← co-mixing → |

Textural properties by mercury pycnometry (except BET)

| | | | | | |
|---|---|---|---|---|---|
| Vtotal (ml/g) | 0.77 | 0.93 | 0.87 | 1.08 | 0.71 |
| Vmeso (mL/g) | 0.54 | 0.69 | 0.66 | 0.50 | 0.36 |
| Dpmeso(nm) | 14.7 | 14.0 | 13.8 | 7.7 | 7.4 |
| Vmacro (mL/g) | 0.23 (30%) | 0.24 (26%) | 0.21 (24%) | 0.58 (54%) | 0.35 (49%) |
| (% of total volume) | | | | | |
| Dpmacro (nm) | 574 | 120 | 145 | 1672 | 1053 |
| S_{BET} (m²/g) | 157 | 215 | 204 | 227 | 311 |

Analyses of the contents of metals (by X-ray fluorescence)

| | | | | | |
|---|---|---|---|---|---|
| % by weight impregnated MoO₃ | 6.05 | 6.01 | 8.24 | 5.94 | 5.89 |
| % by weight impregnated NiO | 1.44 | 1.46 | 1.89 | 1.45 | 1.47 |
| % by weight impregnated P₂O₅ | 1.68 | 1.63 | 2.27 | 1.58 | 1.59 |

### Example 3 (Comparative)

### Preparation of a Catalyst E By Dry Impregnation of an Alumina Support

Catalyst E is a catalyst prepared by mixing-extrusion of boehmite, followed in order by calcination and hydroheat treatment before dry impregnation of the support S(E) with an aqueous solution in such a way that the content of metals is the same as that introduced by co-mixing on catalyst A1.

Catalyst E is prepared by dry impregnation of an alumina support S(E) prepared as hereafter.

An alumina is synthesized in a 5-litre reactor in 3 steps.

The concentrations of the precursors are as follows: aluminium sulphate Al₂(SO₄)₃ at 102 g/L as Al₂O₃ and sodium aluminate NaAlO₂ at 155 g/L as Al₂O₃.

The alumina is manufactured according to the following steps:

a) A first co-precipitation of aluminium sulphate Al₂(SO₄)₃ and sodium aluminate NaAlO₂ at 30° C. and pH=9.1 over8 min: the degree of conversion is 20%. The degree of conversion corresponds to the proportion of alumina formed during the first step, i.e. a final concentration of alumina at 45 g/l. If working in a 5-litre reactor and aiming for 4 l of alumina suspension of final Al₂O₃ concentration of 45 g/l, with a targeted degree of conversion of 20% for the first precipitation step, 20% of the total alumina must be supplied during precipitation step a). The pH of precipitation in the first step is set at 9.1. The quantity of water present initially in the reactor is 1330 ml. For the first precipitation step a) operating at 30° C. for 8 minutes, the flow rate of aluminium sulphate must be 15.2 ml/min, the flow rate of sodium aluminate is 19 ml/min and the flow rate of water is 49.2 ml/min. The mass ratio of sodium aluminate to aluminium sulphate is therefore 1.91.

b) A temperature rise from 30 to 70° C. over 20 to 30 min;

c) A second co-precipitation of aluminium sulphate Al₂(SO₄)₃ and sodium aluminate NaAlO₂ at 70° C. and pH=9.1 over 30 min, with a degree of conversion of 80%;

For the second precipitation step, operating at 70° C., for 30 minutes, the flow rate of aluminium sulphate must be 16.5 ml/min, the flow rate of sodium aluminate is 20 ml/min and the flow rate of water is 30.1 ml/min. The mass ratio of sodium aluminate to aluminium sulphate is therefore 1.84.

d) Filtration by displacement on a device of the Buchner P4 frit type and washing 3 times with 5 L of distilled water;

e) Drying overnight at 120° C.;

The cake is dried (step e) in an oven as a minimum overnight at 120° C. The powder is obtained, which must be formed.

Forming is carried out in a mixer of the Brabender type with an acid level (total, expressed relative to the dry alumina) of 1%, a degree of neutralization of 20% and acidic and basic loss on ignition of 62 and 64% respectively.

Extrusion is carried out on a ram extruder through a trilobed die of diameter 2.1 mm.

After extrusion, the strings are dried overnight at 80° C. and calcined for 2 h at 800° C. under a flow of moist air in a tubular furnace (LHSV=1 l/h/g with 30% water). Extrudates of support S(E) are obtained.

The support S(E) is then impregnated with a metal phase NiMoP by the so-called dry method using the same precursors as in Example 1, i.e. MoO₃, Ni(OH)₂, H₃PO₄. The concentration of the metals in solution fixes the content, the latter having been selected so as to be comparative with that of catalysts A1 and B1. After impregnation, the catalyst undergoes a step of ripening for 24 hours in a water-saturated atmosphere, before being dried for 12 hours at 120° C. under air, and then calcined under air at 400° C. for 2 hours. Catalyst E is obtained. The contents of metals were checked and are shown in Table 2 given above.

### Example 4 (Comparative)

### Preparation of a Co-Mixed Catalyst A2 Not According to the Invention

Catalyst A2 is prepared by co-mixing the active phase with a calcined alumina Al(A2) originating from an alumina gel not prepared according to the invention(degree of conversion of the first step not according to the invention).

The alumina Al(A2) is synthesized following the steps of Example 2 (alumina Al(A1)). The operating conditions are strictly identical, with the exception of the following two points:
In the first precipitation step a), the degree of conversion is 20%.
In the second precipitation step c), the degree of conversion is 80%.

An alumina used according to the invention is synthesized in a 5-litre reactor in 3 steps.

The concentration of the precursors is as follows: aluminium sulphate Al₂(SO₄)₃ at 102 g/L as Al₂O₃ and sodium aluminate NaAlO₂ at 155 g/L as Al₂O₃.

The alumina Al(A2) is manufactured according to the following steps:

a) A first co-precipitation of aluminium sulphate Al₂(SO₄)₃ and sodium aluminate NaAlO₂ at 30° C. and pH=9.1 over 8 min: the degree of conversion is 20%. The degree of conversion corresponds to the proportion of alumina formed during the first step, i.e. a final concentration of alumina at 45 g/l. If working in a 5-litre reactor and aiming for 4 l of alumina suspension of final Al₂O₃ concentration of 45 g/l, with a targeted degree of conversion of 20% for the first precipitation step, 20% of the total alumina must be supplied during precipitation step a). The pH of precipitation in the first step is set at 9.1. The quantity of water present initially in the reactor is 1330 ml. For the first precipitation step a) operating at 30° C. for 8 minutes, the flow rate of aluminium sulphate must be 15.2 ml/min, the flow rate of sodium aluminate is 19 ml/min and the flow rate of water is 49.2 ml/min. The mass ratio of sodium aluminate to aluminium sulphate is therefore 1.91.

b) A temperature rise from 30 to 70° C. over 20 to 30 min;

c) A second co-precipitation of aluminium sulphate Al₂(SO₄)₃ and sodium aluminate NaAlO₂ at 70° C. and pH=9.1 over 30 min, with a degree of conversion of 80%;

For the second precipitation step, operating at 70° C., for 30 minutes, the flow rate of aluminium sulphate must be 16.5 ml/min, the flow rate of sodium aluminate is 20 ml/min and the flow rate of water is 30.1 ml/min. The mass ratio of sodium aluminate to aluminium sulphate is therefore 1.84.

d) Filtration by displacement on a device of the Buchner P4 frit type and washing 3 times with 5 l of distilled water;

e) Drying overnight at 120° C.;

f) Calcination of the powder at 750° C.

Co-mixing takes place in a “Brabender” mixer with a tank of 80 cm³ and a mixing speed of 30 rpm. The alumina powder is put in the tank of the mixer. Then solution A of MoNi(P) is added by syringe over about 2 minutes at 15 rpm. Mixing is maintained for 15 minutes after obtaining a paste at 50 rpm. The paste thus obtained is fed into the MTS capillary rheometer through a 2.1-mm die at 10 mm/min. The extrudates thus obtained are then dried overnight in a stove at 80° C. and then calcined for 2 h under air (1 L/h/g) in a tubular furnace at 400° C.

Catalyst A2 is obtained. Catalyst A2 has the characteristics presented in Table 2. In particular it has an exaggeratedly high macropore volume, at the expense of the mesopore volume, which remains low, and of the median mesopore diameter (Dpmeso), which remains low (below 8 nm).

### Example 5 (Comparative)

### Preparation of the Co-Mixed Catalyst A3 Not According to the Invention

The catalyst A3 not according to the invention is prepared by co-mixing the active phase with an uncalcined boehmite powder B(A3).

A boehmite is synthesized in a 5 L reactor in 3 steps.

The concentrations of the precursors are as follows: aluminium sulphate Al₂(SO₄)₃ at 102 g/l as Al₂O₃ and sodium aluminate NaAlO₂ at 155 g/l as Al₂O₃.

The boehmite B(A3) is manufactured according to the following steps a) to e), under the same conditions as in Example 1, but without the calcination step f):

a) A first co-precipitation of aluminium sulphate Al₂(SO₄)₃ and sodium aluminate NaAlO₂ at 30° C. and pH=9.1 over 8 min: the degree of conversion is 10%. The degree of conversion corresponds to the proportion of alumina formed during the first step, i.e. a final concentration of alumina at 45 g/l.

b) A temperature rise from 30 to 70° C. over 20 to 30 min;

c) A second co-precipitation of aluminium sulphate Al₂(SO₄)₃ and sodium aluminate NaAlO₂ at 70° C. and pH=9.1 over 30 min, with a degree of conversion of 90%;

d) Filtration by displacement on a device of the Buchner P4 frit type and washing 3 times with 5 L of distilled water at 70° C.;

e) Drying overnight at 120° C. in order to obtain a boehmite powder.

No calcination of the powder takes place at this stage.

Solution A is mixed in the presence of the powder of alumina precursor B(A3) (in the form AlOOH) obtained in step e), without subjecting it to any additional heat treatment. It is therefore a boehmite powder. For this purpose, the conditions of mixing utilized are rigorously the same as those described above.

Co-mixing takes place in a “Brabender” mixer with a tank of 80 cm³ and a mixing speed of 30 rpm. The powder is placed in the tank of the mixer. Then the MoNi(P) solution is added by syringe over about 2 minutes at 15 rpm. Mixing is maintained for 15 minutes after obtaining a paste at 30 rpm. The paste thus obtained is fed into the MTS capillary rheometer through a 2.1-mm die at 10 mm/min. The extrudates thus obtained are then dried overnight in a stove at 80° C., and then calcined for 2 h under air (1 L/h/g) in a tubular furnace at 400° C.

The catalyst A3 obtained has the characteristics presented in Table 2. Relative to catalyst A2, the macropore volume is lower, but it is still too high. Moreover, the mesopore volume is very low and the median mesopore diameter (Dₚₘₑₛₒ) is unchanged relative to catalyst A2, and is therefore below 8 nm.

### Example 6

### Evaluation of Catalysts A1, B1, A2, A3 and E in a Model Molecules Test

In applications such as hydrotreating especially of vacuum distillates and residues, the hydrogenating-dehydrogenating function plays a critical role bearing in mind the high content of aromatic compounds in these feedstocks. The toluene hydrogenation test has therefore been used for determining the benefit of catalysts intended for applications such as those targeted here, in particular the hydrotreating of residues.

The catalysts described above in Examples 2 to 5 are sulphurized in situ under dynamic conditions in the traversed fixed bed tubular reactor of a pilot unit of the Microcat type (manufacturer: the Vinci company), with the fluids circulating from top to bottom. Measurements of the hydrogenating activity are carried out immediately after sulphurization under pressure and without re-exposure to air with the hydrocarbon feedstock that was used for sulphurizing the catalysts.

The feedstock for sulphurization and for testing is composed of 5.8% of dimethyl disulphide (DMDS), 20% of toluene and 74.2% of cyclohexane (by weight).

Sulphurization is carried from ambient temperature up to 350° C., with a temperature gradient of 2° C./min, LHSV=4 h⁻¹ and H₂/HC=450 NI/I. The catalytic test is carried out at 350° C. at LHSV=2 h⁻¹ and H₂/HC equivalent to that of sulphurization, with minimum sampling of 4 formulae, which are analysed by gas chromatography.

In this way, the stabilized catalytic activities of equal volumes of catalysts are measured in the hydrogenation reaction of toluene.

The detailed conditions of activity measurement are as follows:
Total pressure: 6.0 MPa
Toluene pressure: 0.37 MPa
Cyclohexane pressure: 1.42 MPa
Methane pressure 0.22 MPa
Hydrogen pressure: 3.68 MPa
H₂S pressure: 0.22 MPa
Catalyst volume: 4 cm³ (extrudates of length comprised between 2 and 4 mm)
Hourly space velocity: 2 h⁻¹
Sulphurization temperature and test temperature: 350° C.

Samples of the liquid effluent are analysed by gas chromatography. Determination of the molar concentrations of unconverted toluene (T) and of the concentrations of its hydrogenation products (methylcyclohexane (MCC6), ethylcyclopentane (EtCC5) and the dimethylcyclopentanes (DMCC5)) makes it possible to calculate a degree of hydrogenation of toluene X_{HYD} defined by:

$${X}_{HYD} ( \% ) = 100 \times \frac{MCC 6 + EtCC 5 + DMCC 5}{T + MCC 6 + EtCC 5 + DMCC 5}$$

The hydrogenation reaction of toluene being of order 1 under the test conditions utilized and the reactor behaving as an ideal piston reactor, the hydrogenating activity A_{HYD} of the catalysts is calculated by applying the formula:

$${A}_{HYD} = ln ( \frac{100}{100 - {X}_{HYD}} )$$

The table given below allows the relative hydrogenating activities of the catalysts to be compared.

TABLE 3
Comparison of the performance in toluene hydrogenation of the
catalysts according to the invention (A1, B1) and comparison with
the catalysts A2, A3 and E not according to the invention

| | State of the | According | | | Relative |
|---|---|---|---|---|---|
| | alumina | to the | | co- | A_{HYD} in rela- |
| Catalyst | precursor | invention? | % MoO₃ | mixed? | tion to E (%) |
| A1 | calcined | yes | 6% | yes | 83 |
| B1 | calcined | yes | 8% | yes | 104 |
| A2 | calcined | no | 6% | yes | 45 |
| A3 | dried | no | 6% | yes | 18 |
| E | calcined | no | 6% | no | 100 |

These catalytic results show the particular effect of co-mixing a metal solution with a particular alumina as described in the invention. It is clearly shown that by carrying out co-mixing according to the invention, in addition to reducing the cost of manufacture of the catalyst, performance is observed that is almost as good as for catalysts prepared by dry impregnation (catalyst E), and far better than for the catalysts co-mixed starting from calcined alumina originating from alumina gels not prepared according to the invention(catalyst A2) or from boehmite (catalyst A3).

### Example 7

### Test-Batch Evaluation of Catalysts A1, B1, A2, A3 and E

Catalysts A1, B1 prepared according to the invention, but also the comparative catalysts A2, A3 and E were subjected to a catalytic test in a perfectly stirred batch reactor, on a feedstock of the Arabian Light VR type (see characteristics in Table 4).

TABLE 4
Characteristics of the feedstock used (Arabian Light VR)

| | | Arabian Light |
|---|---|---|
| Density 15/4 | | 0.9712 |
| Viscosity at 100° C. | mm²/s | 45 |
| Sulphur | % by | 3.38 |
| | weight | |
| Nitrogen | ppm | 2257 |
| Nickel | ppm | 10.6 |
| Vanadium | ppm | 41.0 |
| Aromatic carbon | % | 24.8 |
| Conradson carbon | % by | 10.2 |
| | weight | |
| C7 asphaltenes | % by | 3.2 |
| | weight | |
| SARA | | |
| Saturates | % by | 28.1 |
| | weight | |
| Aromatics | % by | 46.9 |
| | weight | |
| Resins | % by | 20.1 |
| | weight | |
| Asphaltenes | % by | 3.5 |
| | weight | |
| Simulated distillation | | |
| IP | ° C. | 219 |
| 5% | ° C. | 299 |
| 10% | ° C. | 342 |
| 20% | ° C. | 409 |
| 30% | ° C. | 463 |
| 40% | ° C. | 520 |
| 50% | | 576 |
| DS: EP ° C. | ° C. | 614 |
| DS: disti res | % by | 57 |
| | weight | |

For this purpose, after an ex-situ sulphurization step by circulation of an H₂S/H₂ gas mixture for 2 hours at 350° C., the batch reactor is loaded with 15 ml of catalyst with exclusion of air and this is then covered with 90 ml of feedstock. The operating conditions applied are then as follows:

TABLE 5
Operating conditions utilized in the batch reactor

| | | |
|---|---|---|
| Total pressure | 9.5 | MPa |
| Test temperature | 370° | C. |
| Duration of test | 3 | hours |

At the end of the test, the reactor is cooled down and after triple atmosphere stripping under nitrogen (10 minutes at 1 MPa), the effluent is collected and analysed by X-ray fluorescence (sulphur and metals).

The HDS level is defined as follows:

HDS (%)=((% by weight S)_{feedstock}−(% by weight S)_{formula})/(% by weight S)_{feedstock}×100

Similarly, the HDM level is defined as follows:

HDM (%)=((ppmw Ni+V)_{feedstock}−(ppmw Ni+V)_{formula})/(ppmw Ni+V)_{feedstock}×100

The performances of the catalysts are summarized in Table 6. It is clearly shown that by carrying out co-mixing according to the invention, in addition to reducing the cost of manufacture of the catalyst, performance is observed that is at least as good as for catalysts prepared by dry impregnation, and far better than for the catalysts co-mixed starting from calcined alumina originating from alumina gels not prepared according to the invention or from boehmite.

TABLE 6
HDS, HDM performances of the catalysts according to
the invention (A1, B1) and comparison with the catalysts
not according to the invention (A2, A3 and E)

| Catalysts | HDS (%) | HDM (%) |
|---|---|---|
| A1 (according to the invention) | 51.2 | 75.2 |
| B1 (according to the invention) | 52.0 | 75.0 |
| A2 (comparative) | 35.6 | 68.3 |
| A3 (comparative) | 28.4 | 63.2 |
| E (comparative) | 50.3 | 76.1 |

### Example 7

### Evaluation of Catalysts A1 and B1 According to the Invention in Fixed-Bed Hydrotreating and Comparison with the Catalytic Performance of Catalyst E

Catalysts A1 and B1 prepared according to the invention were compared in a test of hydrotreating of petroleum residues with the performance of catalyst E for comparison. The feedstock consists of a mixture of an atmospheric residue (AR) of Middle East origin (Arabian Medium) and a vacuum residue (VR) of Middle East origin (Arabian Light). The feedstock is characterized by high contents of Conradson carbon (14.4% by weight) and asphaltenes (6.1% by weight) and a high quantity of nickel (25 ppm by weight), vanadium (79 ppm by weight) and sulphur (3.90% by weight). The complete characteristics of this feedstock are presented in Table 7.

TABLE 7
Characteristics of the AR AM/VR AL feedstocks used for the tests

| | | AR AM/VR AL mix |
|---|---|---|
| Density 15/4 | | 0.9920 |
| Sulphur | % by | 3.90 |
| | weight | |
| Nitrogen | ppm | 2995 |
| Nickel | ppm | 25 |
| Vanadium | ppm | 79 |
| Conradson carbon | % by | 14.4 |
| | weight | |
| C7 asphaltenes | % by | 6.1 |
| | weight | |
| Simulated distillation | | |
| IP | ° C. | 265 |
| 5% | ° C. | 366 |
| 10% | ° C. | 408 |
| 20% | ° C. | 458 |
| 30% | ° C. | 502 |
| 40% | ° C. | 542 |
| 50% | ° C. | 576 |
| 60% | ° C. | 609 |
| 70% | ° C. | — |
| 80% | ° C. | — |
| 90% | ° C. | — |
| DS: EP ° C. | ° C. | 616 |
| DS: disti res | % by | 61 |
| | weight | |

After a step of sulphurization by circulation of a gas oil cut with added DMDS in the reactor at a final temperature of 350° C., the unit is operated with the petroleum residue described below under the operating conditions of Table 8.

TABLE 8
Operating conditions implemented in the fixed-bed reactor

| | | |
|---|---|---|
| Total pressure | 15 | MPa |
| Test temperature | 370° | C. |
| Hourly space velocity of the | 0.8 | h⁻¹ |
| residue | | |
| Flow rate of hydrogen | 1200 | std I•_{H2}/I•_{feedstock} |

The AR AM/VR AL mixture of feedstocks is injected, then it is heated to the test temperature. After a period of stabilization of 300 hours, the hydrodesulphurization (HDS) and hydrodemetallization (HDM) performances are recorded.

The performances obtained (Table 9) confirm the results from Example 8, i.e. good performances of the co-mixed catalysts according to the invention relative to the reference catalyst, prepared by dry impregnation. The loss of activity relative to the reference is negligible. It therefore appears that the catalysts according to the invention, with a lower cost of manufacture, can give satisfactory activity, almost equivalent to that obtained with a catalyst prepared by dry impregnation. This confirms the benefits of the manner of preparation according to the invention, the latter being easier to implement and consequently much less expensive for the catalyst manufacturer.

TABLE 9
HDS, HDM performances of catalysts A1 and
B1 relative to comparative catalyst E

| Catalysts | HDS (%) | HDM (%) |
|---|---|---|
| A1 (according to the invention) | −1.2% | −1.2% |
| B1 (according to the invention) | −0.5% | −1.7% |
| E (comparative) | Base | Base |

1. Process for the preparation of a catalyst with a co-mixed active phase, comprising at least one metal of group VIB of the periodic table, optionally at least one metal of group VIII of the periodic table, optionally phosphorus and a predominantly calcined alumina oxide matrix, comprising the following steps:
a) a first step of precipitation, in an aqueous reaction medium, of at least one basic precursor selected from sodium aluminate, potassium aluminate, ammonia, sodium hydroxide and potassium hydroxide and of at least one acidic precursor selected from aluminium sulphate, aluminium chloride, aluminium nitrate, sulphuric acid, hydrochloric acid and nitric acid, in which at least one of the basic or acidic precursors comprises aluminium, the relative flow rate of the acidic and basic precursors is selected so as to obtain a pH of the reaction medium comprised between 8.5 and 10.5 and the flow rate of the acidic and basic precursor or precursors containing aluminium is adjusted so as to obtain a degree of conversion of the first step comprised between 5 and 13%, the degree of conversion being defined as the proportion of alumina formed in Al₂O₃ equivalent during said first precipitation step relative to the total quantity of alumina formed at the end of step c) of the preparation process, said step taking place at a temperature comprised between 20 and 90° C. and for a duration comprised between 2 minutes and 30 minutes;
b) a step of heating the suspension at a temperature comprised between 40 and 90° C. for a duration comprised between 7 minutes and 45 minutes,
c) a second step of precipitation of the suspension obtained at the end of the heating step b) by adding, to the suspension, at least one basic precursor selected from sodium aluminate, potassium aluminate, ammonia, sodium hydroxide and potassium hydroxide and at least one acidic precursor selected from aluminium sulphate, aluminium chloride, aluminium nitrate, sulphuric acid, hydrochloric acid and nitric acid, in which at least one of the basic or acidic precursors comprises aluminium, the relative flow rate of the acidic and basic precursors is selected so as to obtain a pH of the reaction medium comprised between 8.5 and 10.5 and the flow rate of the acidic and basic precursor or precursors containing aluminium is adjusted so as to obtain a degree of conversion of the second step comprised between 87 and 95%, the degree of conversion being defined as the proportion of alumina formed in Al₂O₃ equivalent during said second precipitation step relative to the total quantity of alumina formed at the end of step c) of the preparation process, said step taking place at a temperature comprised between 40 and 90° C. and for a duration comprised between 2 minutes and 50 minutes;
d) a step of filtration of the suspension obtained at the end of the second precipitation step c) in order to obtain an alumina gel;
e) a step of drying said alumina gel obtained in step d) in order to obtain a powder;
f) a step of heat treatment of the powder obtained at the end of step e) between 500 and 1000° C., for a duration comprised between 2 and 10 h, in the presence or absence of an air flow containing up to 60% by volume of water in order to obtain a calcined porous alumina oxide;
g) a step of mixing the calcined porous alumina oxide obtained with a solution of at least one metal precursor of the active phase in order to obtain a paste;
h) a step of forming the paste obtained;
i) a step of drying the formed paste at a temperature less than or equal to 200° C. in order to obtain a dried catalyst;
j) an optional step of heat treatment of the dried catalyst at a temperature comprised between 200 and 1000° C., in the presence or absence of water.

2. Process according to claim 1, in which the degree of conversion of the first precipitation step a) is comprised between 6 and 12%.

3. Process according to claim lone of claim 1, in which the degree of conversion of the first precipitation step a) is comprised between 7 and 11%.

4. Process according to claim 1, in which the acidic precursor is selected from aluminium sulphate, aluminium chloride and aluminium nitrate, preferably aluminium sulphate.

5. Process according to claim 1, in which the basic precursor is selected from sodium aluminate and potassium aluminate, preferably sodium aluminate.

6. Process according to claim 1, in which in steps a), b), c) the aqueous reaction medium is water and said steps are carried out with stirring, in the absence of organic additive.

7. Mesoporous and macroporous hydroconversion catalyst comprising:
a predominantly calcined alumina oxide matrix;
a hydro-dehydrogenating active phase comprising at least one metal of group VIB of the periodic table, optionally at least one metal of group VIII of the periodic table, optionally phosphorus,
said active phase being at least partly co-mixed within said predominantly calcined alumina oxide matrix,
said catalyst having a specific surface area Sbet greater than 100 m²/g, a mesopore median diameter by volume comprised between 12 nm and 25 nm inclusive, a macropore median diameter by volume comprised between 50 and 250 nm inclusive, a mesopore volume as measured with a mercury intrusion porosimeter greater than or equal to 0.65 ml/g and a total pore volume measured by mercury porosimetry greater than or equal to 0.75 ml/g.

8. Hydroconversion catalyst according to claim 7 having a mesopore median diameter by volume determined with a mercury intrusion porosimeter comprised between 13 and 17 nm inclusive.

9. Hydroconversion catalyst according to claim 7 having a macropore volume comprised between 15 and 35% of the total pore volume.

10. Hydroconversion catalyst according to claim 7, in which the mesopore volume is comprised between 0.65 and 0.75 ml/g.

11. Hydroconversion catalyst according to claim 7 that does not have micropores.

12. Hydroconversion catalyst according to claim 7, in which the content of group VIB metal is comprised between 2 and 10% by weight of trioxide of group VIB metal relative to the total weight of the catalyst, the content of group VIII metal is comprised between 0.0 and 3.6% by weight of the oxide of group VIII metal relative to the total weight of the catalyst, the content of the element phosphorus is comprised between 0 and 5% by weight of phosphorus pentoxide relative to the total weight of the catalyst.

13. Hydroconversion catalyst according to claim 1, in which the hydro-dehydrogenating active phase is composed of molybdenum, or of nickel and molybdenum, or of cobalt and molybdenum.

14. Hydroconversion catalyst according to claim 13, in which the hydro-dehydrogenating active phase also comprises phosphorus.

15. Hydrotreating process for a heavy hydrocarbon feedstock selected from atmospheric residues, vacuum residues resulting from direct distillation, deasphalted oils, residues from conversion processes such as for example those originating from coking, from fixed-bed, ebullating-bed or moving-bed hydroconversion used alone or in a mixture comprising bringing said feedstock into contact with hydrogen and a catalyst that can be prepared according to claim 1.

16. Hydrotreating process according to claim 15 carried out partly in an ebullating bed at a temperature comprised between 320 and 450° C., under a hydrogen partial pressure comprised between 3 MPa and 30 MPa, at a space velocity advantageously comprised between 0.1 and 10 volumes of feedstock per volume of catalyst per hour, and with a ratio of gaseous hydrogen to liquid hydrocarbon feedstock advantageously comprised between 100 and 3000 normal cubic metres per cubic metre.

17. Hydrotreating process according to claim 15 carried out at least partly in a fixed bed at a temperature comprised between 320° C. and 450° C., under a hydrogen partial pressure comprised between 3 MPa and 30 MPa, at a space velocity comprised between 0.05 and 5 volumes of feedstock per volume of catalyst per hour, and with a ratio of gaseous hydrogen to liquid hydrocarbon feedstock comprised between 200 and 5000 normal cubic metres per cubic metre.

18. Hydrotreating process for a heavy hydrocarbon feedstock of the residue type in a fixed bed according to claim 17 comprising at least:
a) a step of hydrodemetallization
b) a step of hydrodesulphurization
in which said catalyst is used in at least one of said steps a) and b).
